(19) United States
(12) Patent Application Publication
(10) Pub. No.: US 2015/0162675 A1
(43) Pub. Date: Jun. 11, 2015

(54) Enhanced Continuity Connector

(71) Applicant: PerfectVision Manufacturing, Inc., Little Rock, AR (US)

(72) Inventors: Charles Darwin Davidson, JR., Little Rock, AR (US); Glen David Shaw, Conway, AR (US)

(73) Assignee: PERFECTVISION MANUFACTURING, INC., Little Rock, AR (US)

(21) Appl. No.: 14/626,896

(22) Filed: Feb. 19, 2015

Related U.S. Application Data
(63) Continuation-in-part of application No. 14/035,872, filed on Sep. 24, 2013.
Application No. 14/035,872 is a continuation-in-part of application No. 13/527,521, filed on Jun. 19, 2012, now abandoned.
Application No. 13/527,521 is a continuation-in-part of application No. 13/374,378, filed on Dec. 27, 2011, now Pat. No. 8,636,541.

(51) Int. Cl. H01R 9/05; H01R 43/26; H01R 13/52

(52) U.S. Cl. CPC H01R 9/0521; H01R 13/5202; H01R 43/26

(57) ABSTRACT

A male F-Type coaxial cable connector with a body prod, the body prod for urging a connector nut into contact with a connector post.

### PRIORITY APPLICATIONS AND INCORPORATION BY REFERENCE

This application is a continuation-in-part of U.S. patent application Ser. No. 14/035,872 filed Sep. 24, 2013 which is i) a continuation-in-part of U.S. patent application Ser. No. 13/527,521 filed Jun. 19, 2012 and ii) a continuation-in-part of U.S. patent appliction Ser. No. 13/374,378 filed Dec. 27, 2011 now U.S. Pat. No. 8,636,541, all of which are owned by the assignee of the instant application and all of which are now incorporated herein by reference in their entireties and for all purposes.

U. S. Pat. No. 7,841,896 issued Nov. 30, 2010 and U.S. Pat. No. 7,513,795 issued Apr. 7, 2009 are owned by the assignee of the instant application and are now incorporated herein by reference in their entireties and for all purposes.

### BACKGROUND OF THE INVENTION

1. Field of the Invention

The present invention relates generally to coaxial cable connectors. More particularly, the present invention relates to coaxial F-connectors adapted to enhance electrical continuity.

2. Description of the Related Art

Cable television systems and satellite television receiving systems utilize coaxial cable and coaxial cable connectors for distributing signals. As is known in the industry, coaxial connectors such as “F-Type” connectors are commonly used to terminate lengths of coaxial cable. Where an “F” type connector terminates a coaxial cable, a mating connector typically interconnects a device such as a splitter, set top box, or a cable splice.

An electrical junction formed by mated F connectors may be referred to as a “male” F connector mated with a “female” F connector. Where a female F connector is mounted on an item of equipment such as a set top box, it may be referred to as a port. And, where a male F connector is used to terminate a coaxial cable, a common feature of the male connector is use of an attached coaxial cable center conductor as the central or signal contact that mates with a corresponding female connector contact.

Coaxial cable includes concentric conductors in the form of a center conductor spaced apart from a surrounding outer conductor by a dielectric layer. While the center conductor may be a single wire, the outer conductor typically includes a grounding sheath conductor such as tubular sheath formed from braided wire. The braided sheath may overlay yet another ground conductor(s) such as a metallic foil that covers the dielectric. The electrical junction made when F connectors are mated therefore includes a first junction interconnecting center conductors and a second junction interconnecting outer or ground conductors.

Male F-connectors typically include a central post, a body, and a nut. Some of these connectors may further include a means for immobilizing a coaxial cable within the body.

The post provides an electrical conductor for contacting the coaxial cable braid or sheath. A tubular post with an insertable shank that can slide between a coaxial cable's outer braid or sheath and dielectric serves this purpose. Frequently, the shank has a barbed insertable end for enhancing electrical contact and/or mechanical attachment.

The nut is rotatably engaged with the post via an enlarged post end or a post flange opposite the shank. Where the nut of a male F connector is properly threaded onto an F female connector, the enlarged post end is brought into contact with a mating ground conductor such as the metallic body of an F female port. Unreliable and/or intermittent continuity is frequently the result of a loose nut and a ground circuit passing poorly or not at all from the post to an F female port.

Reliable grounding through direct post to port contact requires proper installation techniques in mating male and female connectors. For example, where a male connector includes a threaded nut, proper tightening/torqueing of the nut onto a mating connector is required. When properly installed, the male connector post directly engages an outer conductor of a female connector such as a port ground terminal and a direct electrical connection is established between the post and the ground terminal. If the installer fails to accomplish this, it is doubtful that a reliable or dependable electrical grounding path will be established between the coaxial cable sheath and the female connector.

Notably, F connector installation problems may come to light only after the installer has left the site. For example, operation of the connection may initially be reliable but later become unreliable due to changes such as oxidation and/or deformation of connector metal parts. Further, unintended gaps between metallic parts in the connection invites radio frequency (“RF”) signal ingress and egress that can interfere with or attenuate the signal the coaxial connection is intended to transport.

With growing demands of cable, satellite and broadband operators for more reliable signal distribution, it is, as stated by SCTE, “most desirable to have [connector] contact resistance as close to zero as possible.” (ANSI/SCTE 103 2012 Test Method for DC Contact Resistance, Drop cable to “F” connectors and F 81 Barrels). Notably, this requirement should be met along with others as they may be applicable, for example a nominal 75 ohm impedance, environmental seals such as moisture sealing, service life measured in years, tolerance to wide temperature extremes, cable/connector insertion and retention forces, and in cases more. (SCTE-103-2004 (DC contact resistance): ANSI/SCTE 60-2004 (Moisture Migration test): ASTM-B117-03 (Salt Spray test): ANSI/SCTE-99-2004 (Axial Pull test): SCTE-98-2004 (Tightening Torque): SCTE-73-2002 (Coaxial Insertion Force): SCTE-48-3-2004 (Shielding Effectiveness): ANSI/SCTE-04-1997 (F Connector Return Loss): SBCA standards of Physical Dimension Tolerance: GR-1503-core, Issue 1, March 1995 UV degradation).

### BRIEF SUMMARY OF THE INVENTION

In the present invention, a male F-Type coaxial cable connector includes a body with a body prod for urging a connector nut into contact with a connector post.

In an embodiment, a male F-Type coaxial cable connector comprises: a coaxially arranged nut, post, and plastic body; a post flange rotatably retaining the nut; the body having a leading end and a trailing end, the leading end fixedly engaging the post; a blocking ring carried by an end cap, the blocking ring for fixing a coaxial cable within the connector when the end cap is advanced over the body; a nut contactor integral with the body and proximate the body leading end; and, the nut contactor urging the nut into contact with the post flange; wherein the nut contactor includes a resilient tab and a pocket behind the tab, the pocket providing a tab deflection space for receiving the tab when it is deflected by a force the nut exerts on the tab; wherein the connector completes an electrical path between a coaxial cable outer conductor and a mating connector ground terminal via (i) contacting the outer conductor with the post, (ii) contacting the post with the nut, and (iii) contacting the nut with the ground terminal.

In various embodiments, additional features include one or more of the following. The tab contacts the nut via a tab finger that projects axially from a tab surface toward the nut. A plurality of the nut contactors, spaced apart and circumferentially arranged; and, body material isolating each pocket from adjacent pockets. A pocket aspect ratio apparent on a surface of the body has a value about equal to one. A tab has a trapezoidal shape. A radial line passing through a pocket bottom defines a body material thickness and a pocket depth, the pocket depth exceeding the body material thickness. A tab boundary includes a tab free end and but for the tab free end, the tab boundary is contiguous with the body. Body slots flanking generally opposed edges of the tab. The generally opposed tab edges, a tab free end, and a tab base substantially form a tab boundary. The tabs are radially tapered away from the tab base. A tab is axially thickest at its base. A tab slopes from its free end near a pocket top to its base near a pocket bottom, a pocket top axial dimension exceeding a pocket bottom axial dimension.

In another embodiment, a male F Type coaxial connector with a post and a nut retained by a post flange and a method of continuously urging movement of the nut along a connector central axis to abut the flange, the method comprising the steps of: providing a coaxially arranged connector body having a neck adjoining a sleeve, the neck encircling and fixed to the post; forming plural voids in the neck, each void isolated from adjacent voids by body material and each void between axially separated end portions of the neck; and urging axial movement of the nut to abut the flange via a nut abutment integral with the neck.

In various embodiments, additional features include one or more of the following. The voids are evidenced by respective holes in an outer surface of the neck. The nut abutment presents a smooth surface where it contacts the nut.

Notably, selected embodiments of the present invention may provide one or more of: proper continuity in a coaxial connector, even though torque requirements have been ignored; reliable continuity between a connector and a socket or port, even if the connector is not fully tightened; a compressible coaxial cable connector which establishes and maintains reliable electrical continuity; a coaxial connector that can be manufactured economically; a connector of the character described that establishes satisfactory EMI and RFI shielding; a connector of the character described that establishes reliable continuity between critical parts during installation of the male connector to the various types of threaded female connections, even though applied torque may fail to meet specifications; a proper ground electrical path with a socket even where the male connector is not fully torqued to the proper settings; minimized resistive losses in a coaxial cable junction; operation with bandwidth approximating three GHz; an F-connector adapted for home satellite and cable systems distributing multiple, high definition television channels; a connector of the character described that is weather proof and moisture resistant; and, a compression F-connector of the character described that can be safely and properly installed without deformation of critical parts during final compression.

### BRIEF DESCRIPTION OF THE DRAWINGS

The present invention is described with reference to the accompanying figures. These figures, incorporated herein and forming part of the specification, illustrate embodiments of the invention and, together with the description, further serve to explain its principles enabling a person skilled in the relevant art to make and use the invention.

FIG. 1 is a perspective front view of an enhanced continuity connector in accordance with an embodiment of the present invention.

FIG. 2 is a perspective rear view of the connector of FIG. 1;

FIG. 3 is an cross-sectional exploded view of the connector of FIG. 1;

FIGS. 4A-E show embodiments of the connector of FIG. 1.

FIGS. 5A-D show views of a body for use with the connector of FIG. 1.

FIGS. 6A-C show views of another body for use with the connector of FIG. 1.

### DETAILED DESCRIPTION

The disclosure provided herein describes examples of some embodiments of the invention. The designs, figures, and descriptions are non-limiting examples of the embodiments they disclose. For example, other embodiments of the disclosed device and/or method may or may not include all of the features described herein. Moreover, disclosed advantages and benefits may apply to only certain embodiments of the invention and should not be used to limit the disclosed invention.

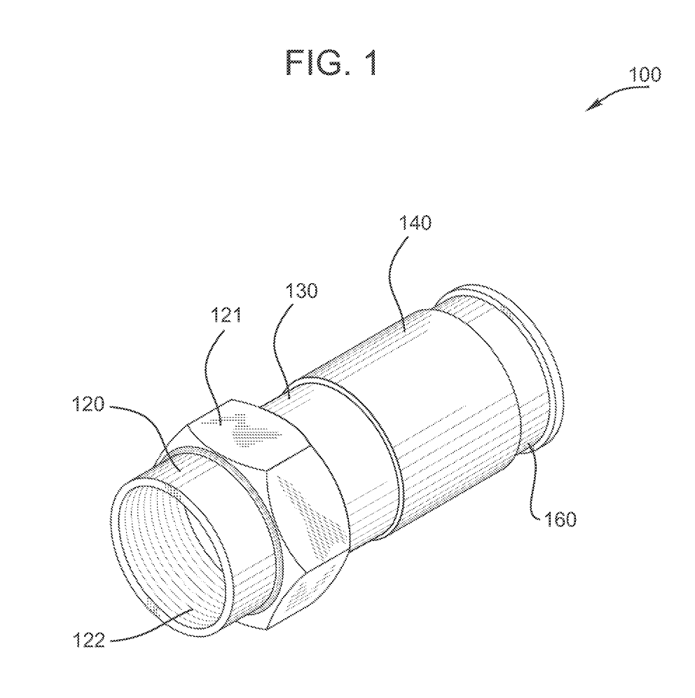

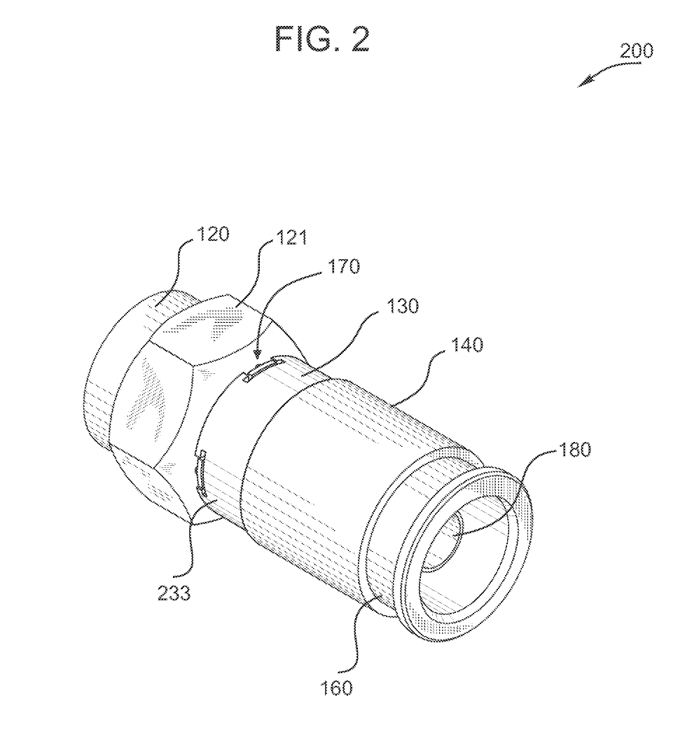

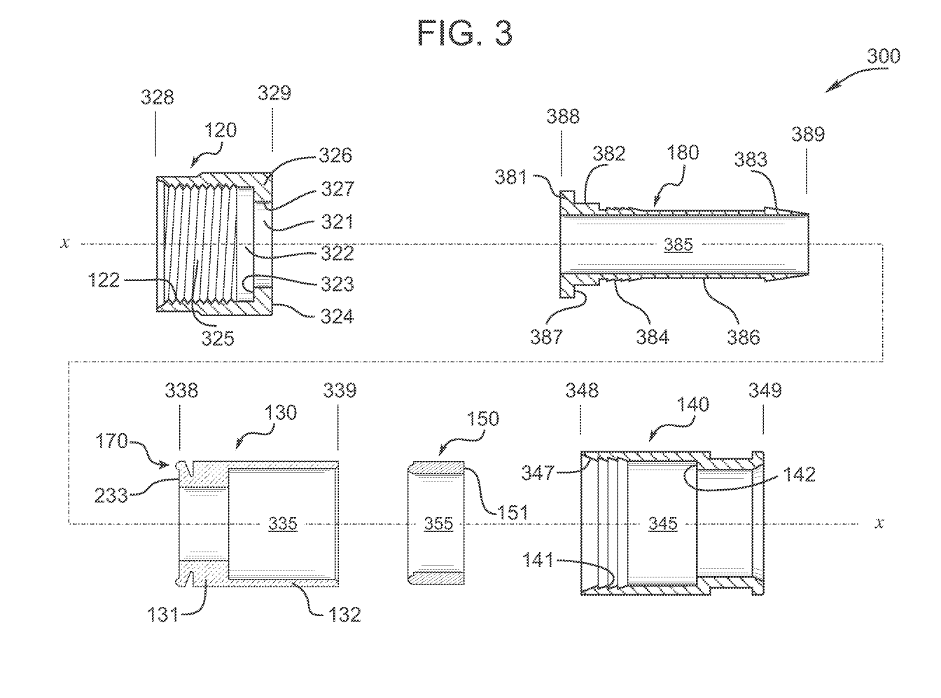

FIG. 1 shows a perspective front view 100 of a male F-Type connector of the present invention. FIG. 2 shows a perspective rear view 200 of the same connector.

FIGS. 1-2 show connector parts including a connector fastener such as a nut 120 with internal threads 122, a connector body 130, and an end cap 140. The nut may include peripheral flats 121 for grasping and turning/torqueing the nut with a wrench. And, the end cap may include an outer circumferential groove 160 for receiving a marker or identification band. In various embodiments the nut and end cap incorporate or are made from conductive material(s) including metals such as brass or copper alloys.

Visible in the rear view of FIG. 2 is a nut contactor 170. The contactor is proximate a forward end of the body 233 and in some embodiments is integral with the body. Embodiments of the contactor and/or body may incorporate or be made from non-conductive material(s) including polymers such as a resilient plastic.

Concerning application with various coaxial cable sizes and structures, the connector 100 may be designed to accommodate different coaxial cables. For example, embodiments of the connector may be used to terminate Series-6, Series-59, and other coaxial cables with varying structures such as dual-shields, tri-shields, and quad-shields.

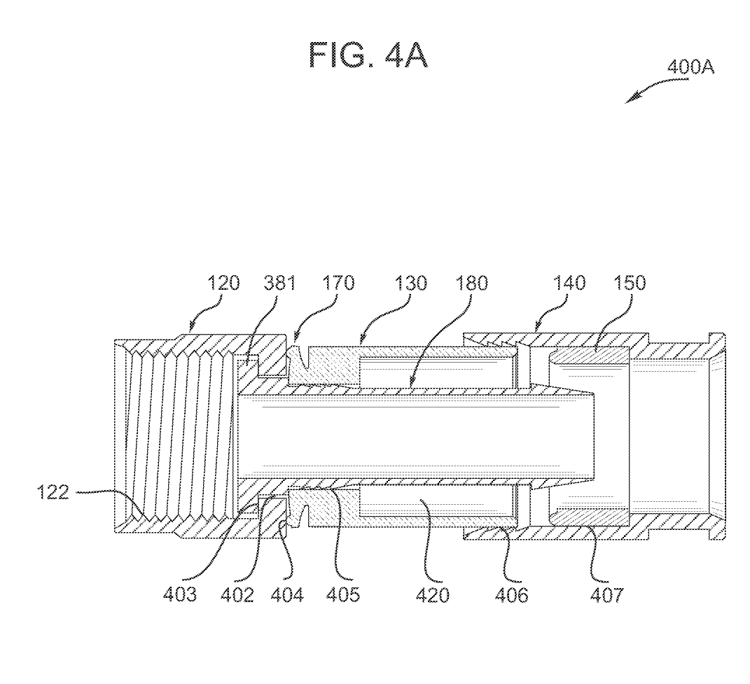

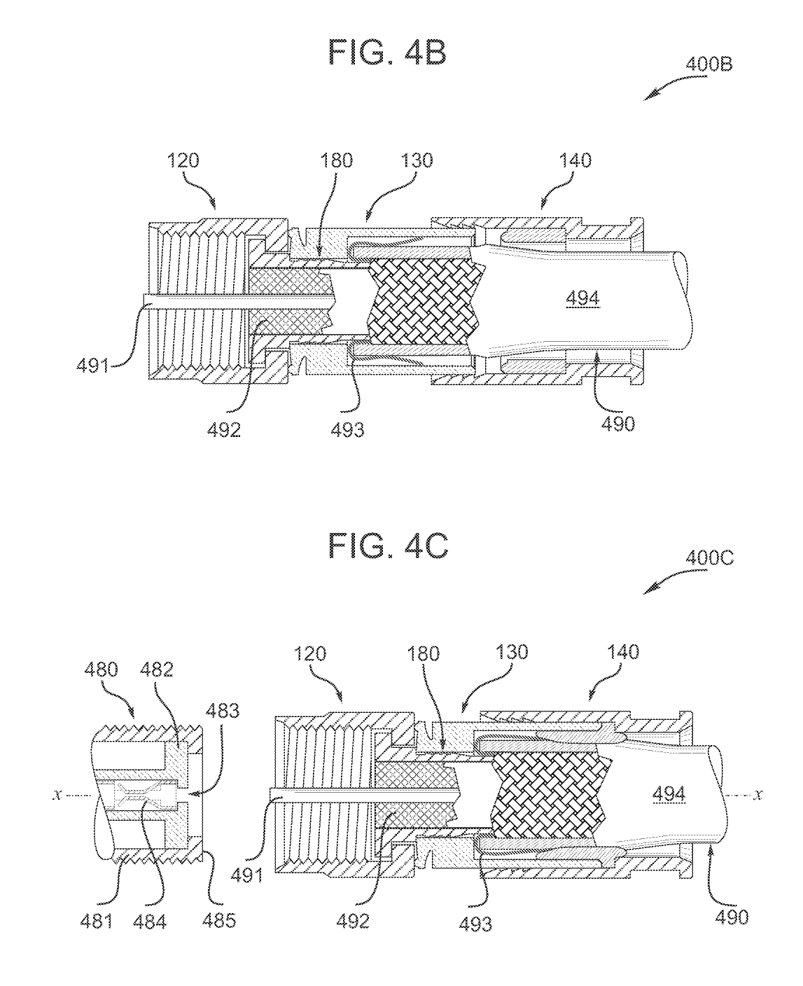

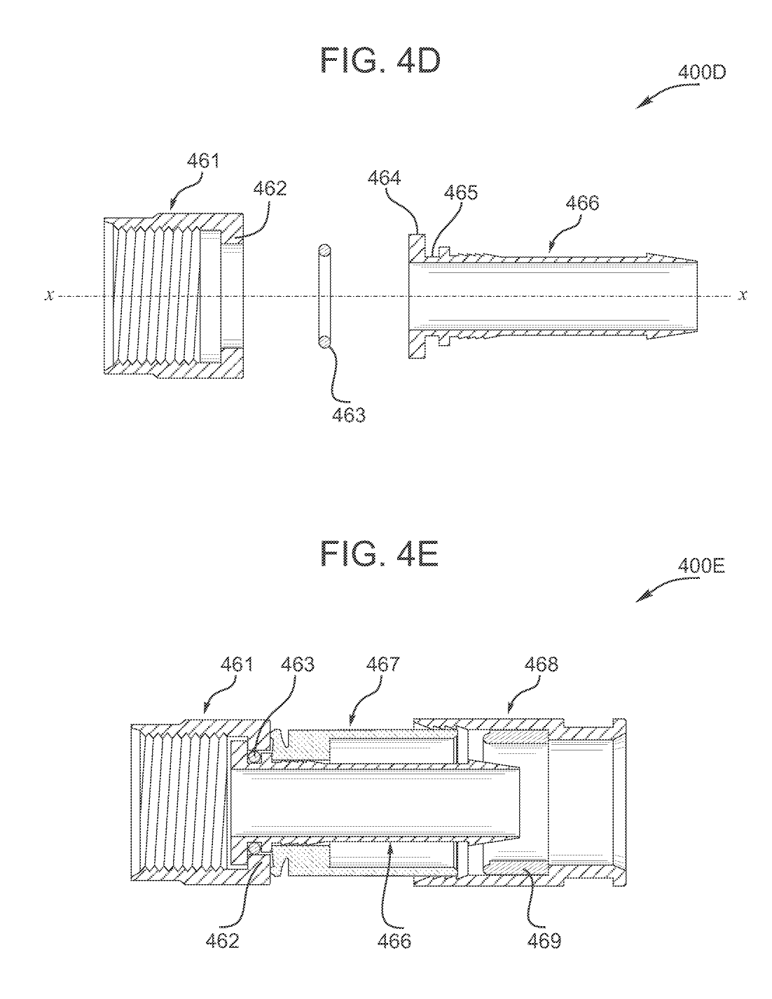

FIGS. 3, 4A show an exploded view 300 and a cross-sectional side view 400A of the connector of FIG. 2. Connector parts include a nut 120, body 130, and post 180. Various embodiments also include an end cap 140 and a ring 150. Each of these parts is concentrically arranged about a longitudinal or central axis x-x and may be referred to as having a leading end or end portion and a trailing end or end portion with respect to the axis.

The tubular post 180 is for engaging the rotatable nut 120 and the body 130 while the end cap 140 is for engaging the body 130. In an assembled connector, interfaces among these parts may include one or more of a longitudinal nut-post interface 402, a radial nut-post interface 403, a body-nut interface 404, a body-post interface 405, an end cap-body interface 406, and an end cap-ring interface 407.

The post 180 extends between leading and trailing ends 388, 389 defining a hollow interior 385 therebetween. A nut retainer such as an enlarged end part or flange 381 adjoins a post shank 386. In various embodiments, the post trailing end includes a radial projection such as a barb 383 for enhancing mechanical and/or electrical engagement with a coaxial cable.

Features of the post may include, behind the enlarged end portion 381, nut-post and body-post interface portions such as a circumferential post shoulder 382 and an adjacent body engagement 384 with an upset or roughened outer surface.

The nut 120 extends between leading and trailing ends 328, 329 and defines a hollow interior 325 therebetween. The nut is for rotatable engagement with the post 180 and the post enlarged end 381 is for retaining the nut while enabling the nut to rotate about the post.

Features of the nut may include, near the nut trailing end, a nut-post interface portion such as an inwardly directed flange or rim 326 and near the nut leading end a female F connector interface such as a nut mouth or a threaded nut mouth 122. In various embodiments the nut includes a nut-post interface portion formed by nut cavity 322 surfaces that lie between the threads 122 and rim 326. For example, nut cavity surfaces may include an internal nut rim surface 323 and a nut sidewall surface 327.

The body 130 extends between leading and trailing ends 338, 339 and defines a hollow interior 335 therebetween. The body is for fixed engagement with the post 180 and for forming an annular space between the body and the post 180.

Features of the body may include a body neck 131 near the body leading end 338 that forms a portion of the body-post interface and an adjacent body sleeve 132 terminating at the body trailing end 339. In various embodiments, a radial (about perpendicular to the longitudinal axis x-x) wall thickness of the body neck is greater than a radial wall thickness of the body sleeve.

In various embodiments, a connector part such as the body 130 is designed to push the nut 120 against the post 180. For example, a leading body end 338 that is resilient and abuts a nut rearward facing nut surface 324 may serve to urge the nut into contact with the post at a post surface such as a rearward facing surface of the enlarged post end 387. In some embodiments, a nut contactor integral with the body 170 provides a means such as spring-like means for urging of the nut against the post.

The end cap 140 extends between leading and trailing ends 348, 349 and defines a hollow interior 345 therebetween. The end cap leading end is for sliding over the body trailing end 339. In various embodiments, the end cap is for internally carrying a ring such as a sealing, blocking, and/or compressing ring 150 having a ring interior 355.

Features of the end cap 140 may include a grasping mouth 141 at the leading end 348 and an inwardly directed shoulder 142 near the trailing end 349. The grasping mouth may include sloped ridges 347 projecting toward the axis x-x and providing a means for fixing the end cap in a final position on the body when the end cap is fully advanced onto the body to fix a coaxial cable therein. During advancement, the inwardly directed end cap shoulder pushes the ring 150 via a trailing ring face 151 toward the nut 120, for example into an annular space formed between the post 180 and the body 130 of an assembled connector.

FIGS. 4B-C show cross-sectional side views 400B, 400C of a coaxial cable inserted in the connector of FIG. 4A. FIG. 4B shows a prepared end of a coaxial cable 490 is inserted in the connector before the end cap 140 is advanced on the body 130. As seen, the coaxial cable includes a dielectric 492 encircling a center conductor 491. The dielectric is encircled by a conductive outer braid or sheath 493 and an outermost jacket 494 such as a plastic or PVC jacket encircles the sheath. Notably, when the coaxial cable is inserted in the connector, an end of the connector post such as a barbed end 383 is inserted into the end of the coaxial cable between the dielectric layer 492 and the sheath outer conductor 493 such that a post hollow space 385 receives the coaxial cable center conductor and dielectric.

As shown in FIG. 4C, the prepared end of a coaxial cable 490 is fixed in the connector when the end cap 140 is advanced on the body 130 such that the ring 150 is pushed into the annular body space 420 and presses the coaxial cable sheath 493 against the post 180.

Shown adjacent to the F male connector is an F female connector portion including an outer metal case providing a case or a signal ground 481 and an internal center contact 484 for receiving a coaxial cable center conductor. In various embodiments, the case may be threaded 480. Access to the internal center contact is typically via an aperture 483 of an insulator 482 fixed at an end of the metal case 485.

As skilled artisans will appreciate, electrical continuity between the coaxial cable sheath 493 and the female connector metal case or ground 485 requires an electrical junction between the post 180 and the case 481. In particular, a first continuity path from the post 180 to the case 481 is required unless a second continuity path such as a continuity path from the post 180 to the nut 120 to the case 481 exists. Moreover, this second continuity path post-nut-case may be adapted to reliably provide continuity when the post-case continuity path is unreliable, for example due to improper coaxial connector mating.

FIGS. 4D-E show connector parts and a connector 400D-E similar to the connector parts and connector of FIGS. 3, 4A. In particular, the connector parts of FIG. 4D include a nut 461, a post 466 with a post flange 464, a body 467, and end cap 468, and a sealing, blocking, or compression ring 469. Also shown is a second ring 463. Located in a groove 465 behind the post flange, the second ring is for mating with an inwardly turned rim 462 of the nut 461. In various embodiments, the second ring is an elastomeric or plastic O-Ring and in various embodiments the ring is for sealing between the nut and the post. Notably, any of the bodies discussed herein may be used with the connector of FIG. 4E.

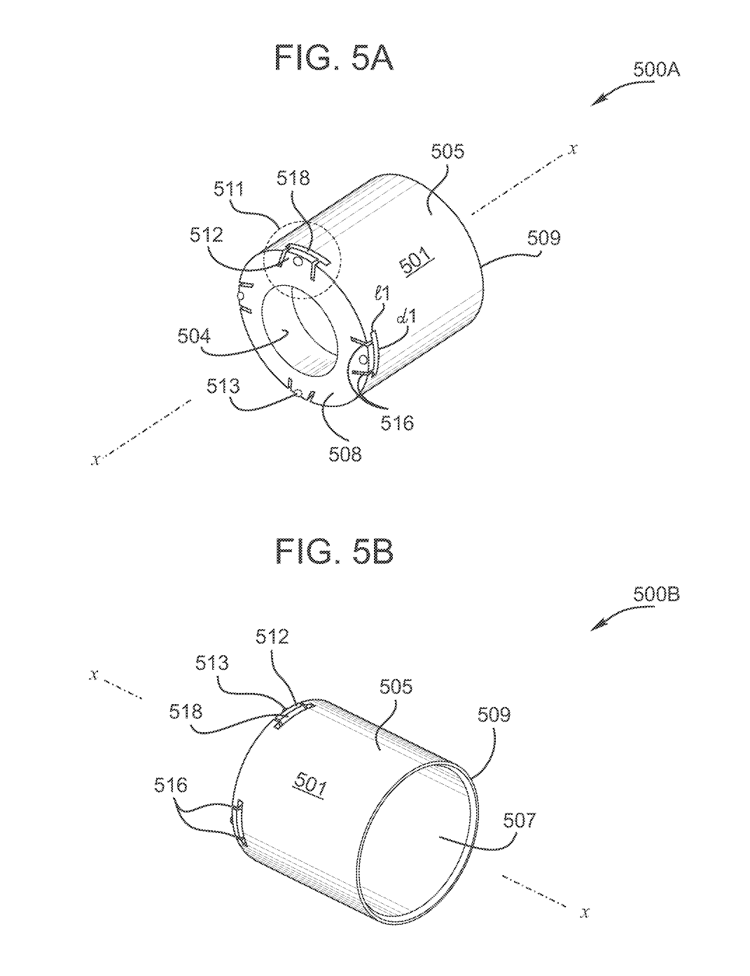

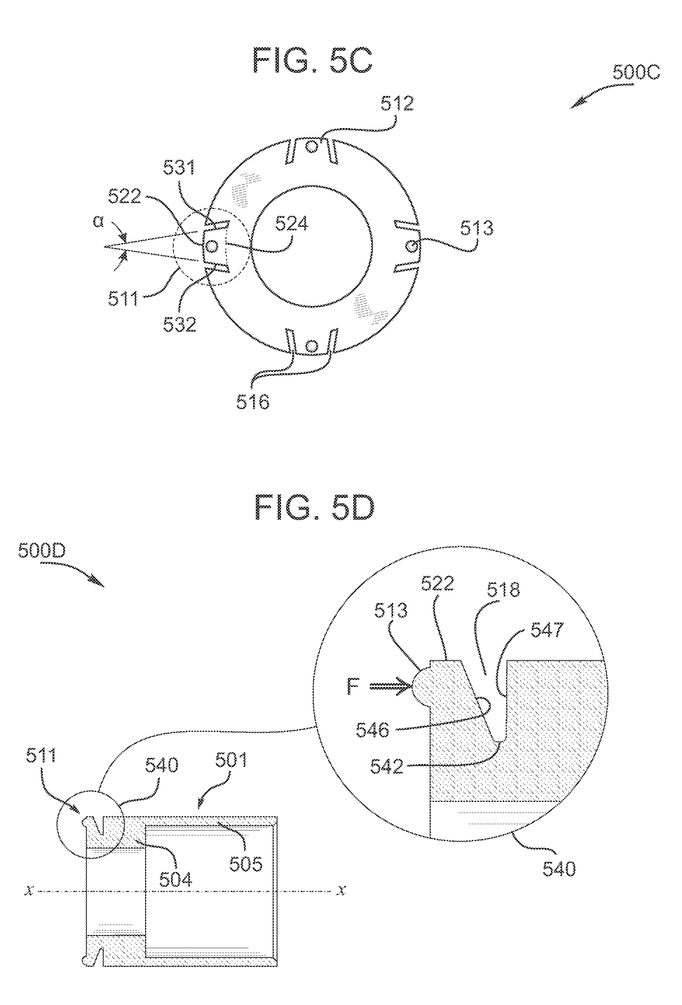

FIGS. 5A-B show perspective front and rear views of a body 500A-B for use with the connector of FIG. 1. The body 501 includes a leading or neck portion 504 adjoining a trailing or sleeve portion 505. Located between a body leading end or end portion 508 and a body trailing end or end portion 509 is hollow space 507 defined by the body. In various embodiments, the body is adapted to push against an adjacent fastener such as a nut 120.

Features of the body may include one or more nut contactors such as a group of circumferentially arranged nut contactors 511. In various embodiments, a nut contactor includes a deflectable prod portion such as a deflecting arm or tab 512. The deflectable prod portion is for pushing an adjacent nut 120 directly, or indirectly. Indirect pushing means may include a tab projection such a finger 513 that extends axially x-x as from a tab surface to contact a nut 120. In some embodiments, three or four nut contactors located near the body leading end 508 are equally circumferentially spaced for, inter alia urging non-binding movement of the nut along a post 180.

Where the body 501 is made from a suitably resilient material, deflection may be provided by compression of the body material. Deflection may also be provided by a thinned body part that deflects or bends. For example, the tab 512 of FIG. 5A is a thinned body part that extends from a tab base 524, between generally opposed body slots 516, to an opposed tab free end 522 (see also FIGS. 5C-D).

A body relief void 518 formed where body material behind the tab has been removed provides a deflection space or pocket for the tab. And in embodiments having plural tabs and respective pockets, each of the pockets may be isolated as by body material from adjacent pockets. Skilled artisans will appreciate less force is required to deflect this tab 512 than is required to compress the body 130 material.

An aspect ratio of the void 518 in a body outer surface is shown with lengths d1 by l1. Where d1 is large as compared with l1, a narrow void is formed. And, where d1 is not large as compared with l1, a void that is not narrow is formed. For example, a narrow aspect ratio exists when d1 is about three or more times greater than l1 and an aspect ratio that is not narrow exists when l1 is about equal to or greater than d1.

FIG. 5C shows a front view 500C of the body of FIG. 5A. In the figure, each of four nut contactors 511 includes a corresponding tab 512 and each tab is bordered by a base 524, a free end 522, and generally opposed sides 531, 532. The generally opposed sides define an angle α therebetween. In the embodiment shown, the tab's shape is similar to that of a trapezoid. In other embodiments, the tab shape may be curved, semicircular, rectangular or another suitable shape.

FIG. 5D shows side cross-sectional view 500D of the body of FIG. 5A. Here, the body 501 is shown including a neck 504 and a sleeve 505 trailing from the neck. An enlarged view 540 of a nut contactor 511 illustrates an embodiment of the relief void 518 that provides a deflection space for a tab 512 deflected by an opposing force F such as a force the nut 120 exerts on the tab. As seen, the void extends between a root 542 and a location near the tab free end 522.

The void 518 has generally opposed leading and trailing side walls 547, 546 adjoining the root 542 and the sidewalls may be smooth (as shown) or otherwise. The sidewalls may be parallel or not, for example not parallel as shown to accommodate greater deflection. The root may be radiused or not, for example radiused as shown to mitigate body 501 cracks. In some alternative embodiments, the void is a radial through-hole of a suitable cross-section.

In some embodiments the tab is radially tapered or reduced, for example thicker along a line parallel to the x-x axis at the tab base (see e.g. FIG. 5D) and/or for example thicker along a line perpendicular to the x-x axis at the tab base (see e.g. FIG. 5C).

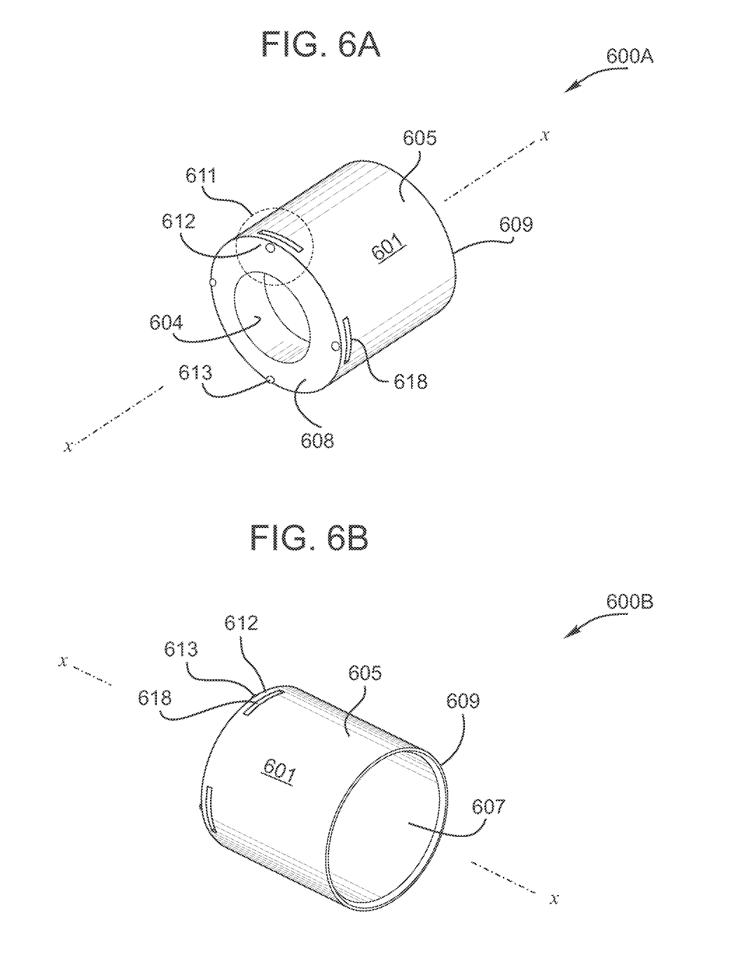

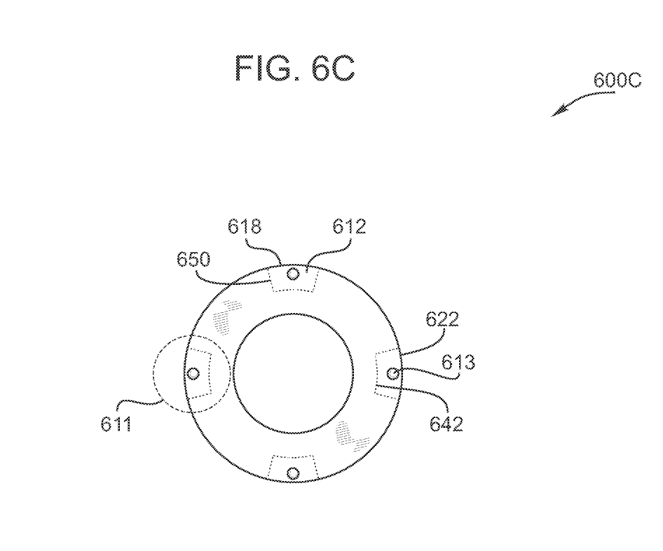

FIGS. 6A-B show perspective front and rear views of another body 600A-B for use with the connector of FIG. 1. The body 601 includes a leading or neck portion 604 adjoining a trailing or sleeve portion 605. Located between a body leading end or end portion 608 and a body trailing end or end portion 609 is hollow space 607 defined by the body. In various embodiments, the body is adapted to push against an adjacent fastener such as a nut 120.

Features of the body may include one or more nut contactors such as a group of circumferentially arranged nut contactors 611. In various embodiments, a nut contactor includes a deflectable prod portion such as a deflecting diaphragm or tab 612. The deflectable prod portion is for pushing an adjacent nut 120 directly, or indirectly. Indirect pushing means may include a tab projection such a finger 613 that extends axially x-x to contact a nut 120. In some embodiments three or four nut contactors located near the body leading end 608 are equally circumferentially spaced for, inter alia urging non-binding movement of the nut along a post 180.

Where the body 601 is made from a suitably resilient material, deflection may be provided by compression of the body material. Skilled artisans will recognize that connector bodies having voids or pockets beneath a body end facing the nut provides a means of controlling the compressibility of all or a portion, such as a peripheral portion, of the body end.

Deflection may also be provided by a thinned body part that deflects or bends. For example, the tab 612 of FIG. 6A is a thinned body part similar in some respects to the tab 512 of FIG. 5A. However, unlike the tab of FIG. 5A, the tab of FIG. 6A does not have slots 516 as boundaries. Skilled artisans will appreciate less force is required to deflect this tab 612 than is required to compress the body 130 material.

A body relief void 618 formed where body material behind the tab has been removed provides a deflection space or a pocket for the tab. And in embodiments having plural tabs and respective pockets, each of the pockets may be isolated from adjacent pockets. Because the tab has no slot boundaries 516, the relief void is surrounded by a continuous sidewall shown here as a tube of somewhat rectangular cross-section radiating from the longitudinal connector axis x-x.

FIG. 6C shows a front view 600C of the body of FIG. 6A. In the figure, each of four nut contactors 611 includes a corresponding tab 612. Hidden lines 650 of the relief void 618 indicate a tab outline shown here as somewhat trapezoidal in shape. In other embodiments, tab shapes may be curved, semicircular, rectangular or another suitable shape.

In various embodiments, the void extends between a root 642 and a location near a tab free end 622. The void sidewalls may be parallel or not, for example not parallel to accommodate greater deflection. The root may be radiused or not, for example radiused as shown to mitigate body 601 cracks. In some alternative embodiments, the void is a radial through-hole of a suitable cross-section.

Embodiments of F male coaxial cable connectors e.g. 100 of the present invention enhance continuity of an electrical path through the connector. For example, where continuity from a) the sheath 493 of a coaxial cable 490 fitted to a male connector to b) a mated female connector case or ground 481 via direct post 180 to case contact is unreliable, a nut contactor 170 such as a nut contactor integral with the body provides sheath to case continuity by pushing an electrically conductive nut into contact with an enlarged post end 381 irrespective of whether the male connector is properly fitted and/or tightened onto a mating connector.

Where the nut contactor 170 is continuously pushing against the nut 120, skilled artisans will appreciate the need to choose nut materials, nut contactor materials and geometry, and interengaging forces therebetween to manage friction resisting nut rotation to industry acceptable levels while maintaining sufficient force for engaging the nut and post 180 to assure reliable nut to post electrical continuity.

While various embodiments of the present invention have been described above, it should be understood that they have been presented by way of example only, and not limitation. It will be apparent to those skilled in the art that various changes in the form and details can be made without departing from the spirit and scope of the invention. As such, the breadth and scope of the present invention should not be limited by the above-described exemplary embodiments, but should be defined only in accordance with the following claims and equivalents thereof.

What is claimed is:

1. A male F-Type coaxial cable connector comprising:
a coaxially arranged nut, post, and plastic body;
a post flange rotatably retaining the nut;
the body having a leading end and a trailing end, the leading end fixedly engaging the post;
an end cap;
a nut contactor integral with the body and proximate the body leading end; and,
the nut contactor urging the nut into contact with the post flange;
wherein the nut contactor includes a resilient tab and a pocket behind the tab, the pocket providing a tab deflection space for receiving the tab when it is deflected by a force exerted on the tab by the nut.

2. The connector of claim 1 wherein the tab contacts the nut via a tab finger that projects axially from a tab surface toward the nut.

3. The connector of claim 1 further comprising:
a plurality of the nut contactors, spaced apart and circumferentially arranged; and,
body material isolating each pocket from adjacent pockets.

4. The connector of claim 3 wherein a pocket aspect ratio apparent on a surface of the body has a value about equal to one.

5. The connector of claim 3 wherein the tab has a trapezoidal shape.

6. The connector of claim 3 wherein at a radial line passing through a pocket bottom indicates a body material thickness and a pocket depth, the pocket depth exceeding the body material thickness.

7. The connector of claim 3 wherein a tab boundary includes a tab free end and except for the tab free end, the tab boundary is contiguous with the body.

8. The connector of claim 3 further comprising:
body slots flanking generally opposed edges of the tab.

9. The connector of claim 8 wherein the generally opposed tab edges, a tab free end, and a tab base substantially form a tab boundary.

10. The connector of claim 9 wherein the tabs are radially tapered away from the tab base.

11. The connector of claim 10 wherein a tab is axially thickest at its base.

12. The connector of claim 9 wherein a tab slopes from its free end near a pocket top to its base near a pocket bottom, a pocket top axial dimension exceeding a pocket bottom axial dimension.

13. In a male F Type coaxial connector with a post and a nut retained by a post flange, a method of continuously urging movement of the nut along a connector central axis to abut the flange, the method comprising the steps of:
providing a coaxially arranged connector body having a neck adjoining a sleeve, the neck encircling and fixed to the post;
forming plural voids in the neck, each void isolated from adjacent voids by body material and each void between axially separated end portions of the neck; and,
urging axial movement of the nut to abut the flange via a nut abutment integral with the neck.

14. The method of claim 13 wherein the voids are evidenced by respective holes in an outer surface of the neck.

15. The method of claim 13 wherein the nut abutment presents a smooth surface where it contacts the nut.

16. A male F-Type coaxial cable connector comprising:
a coaxially arranged nut, post, and plastic body;
a post flange rotatably retaining the nut;
the body having a leading end and a trailing end, the leading end fixedly engaging the post;
a blocking ring carried by an end cap, the blocking ring for fixing a coaxial cable within the connector when the end cap is advanced over the body;
a nut contactor integral with the body and proximate the body leading end; and,
the nut contactor urging the nut into contact with the post flange;
wherein the nut contactor includes a resilient tab and a pocket behind the tab, the pocket providing a tab deflection space for receiving the tab when it is deflected by a force the nut exerts on the tab;
wherein the connector completes an electrical path between a coaxial cable outer conductor and a mating connector ground terminal via (i) contacting the outer conductor with the post, (ii) contacting the post with the nut, and (iii) contacting the nut with the ground terminal.

17. The connector of claim 16 wherein the tab contacts the nut via a tab finger that projects axially from a tab surface toward the nut.

18. The connector of claim 16 further comprising:
a plurality of the nut contactors, spaced apart and circumferentially arranged; and,
body material isolating each pocket from adjacent pockets.

19. The connector of claim 18 wherein a pocket aspect ratio apparent on a surface of the body has a value about equal to one.

20. The connector of claim 18 wherein a tab boundary includes a tab free end and but for the tab free end, the tab boundary is contiguous with the body.

21. The connector of claim 18 further comprising:
body slots flanking generally opposed edges of the tab.
